(19) United States
(12) Patent Application Publication
(10) Pub. No.: US 2025/0018613 A1
(43) Pub. Date: Jan. 16, 2025

(54) RECYCLING CARBON FIBER COMPOSITES USING ELECTROMAGNETIC FIELDS

(71) Applicants: The Texas A&M University System, College Station, TX (US); Texas Research Institute Austin, Inc., Austin, TX (US)

(72) Inventors: Micah J. Green, College Station, TX (US); Mohammad G. Naraghi, Cypress, TX (US); Aniruddh Vashisth, College Station, TX (US); Spencer Hawkins, Leander, TX (US)

(73) Assignees: The Texas A&M University System, College Station, TX (US); Texas Research Institute Austin, Inc., Austin, TX (US)

(21) Appl. No.: 18/709,507

(22) PCT Filed: Nov. 17, 2022
(86) PCT No.: PCT/US2022/050250

§ 371 Date: May 12, 2024

Related U.S. Application Data
(60) Provisional application No. 63/281,078, filed on Nov. 19, 2021.

(51) Int. Cl. B29B 17/02; B29B 17/04; B29K 105/08; B29K 105/26; B29K 307/04

(52) U.S. Cl. CPC B29B 17/0206; B29B 17/04; B29B 2017/0496; B29K 2105/0854; B29K 2105/26; B29K 2307/04

(57) ABSTRACT

In an embodiment, the present disclosure pertains to a method of recycling that includes applying an electromagnetic field to a composite material having carbon fiber therein, heating the composition, degrading a matrix of the composite material, and recovering the carbon fiber from the composite material. In an additional embodiment, the present disclosure pertains to a method of non-contact recycling that includes applying an electromagnetic field to a composite material having carbon fiber therein with an electromagnetic applicator via at least one of direct current or alternating current, heating the composition, degrading a matrix of the composite material, and recovering the carbon fiber from the composite material. In some embodiments, the electromagnetic field is applied in a non-contact manner. In some embodiments, the heating is locally induced heating that includes increasing the temperature inside the composite material via an inside-out method thereby initiating pyrolysis within the composite material.

### CROSS-REFERENCE TO RELATED APPLICATIONS

This patent application claims priority from, and incorporates by reference the entire disclosure of, U.S. Provisional Patent Application No. 63/281,078, filed on Nov. 19, 2021.

### TECHNICAL FIELD

The present disclosure relates generally to recycling carbon fiber composites and more particularly, but not by way of limitation, to recycling carbon fiber composites using electromagnetic fields.

### BACKGROUND

This section provides background information to facilitate a better understanding of the various aspects of the disclosure. It should be understood that the statements in this section of this document are to be read in this light, and not as admissions of prior art.

Carbon fiber reinforced composites (CFRCs) have myriad applications in the military, aerospace, and automotive industries. Their popularity is due to the superior properties of carbon fibers, such as high tensile strength, light weight, and high modulus. CFRCs can be broadly classified into thermoplastic composites and thermoset composites based on the type of matrix used. Here, we focus on the specific challenge of recycling continuous carbon fibers from thermoset CFRCs. The matrix in thermoset composites is usually the product of an irreversible crosslinking reaction; thus, it cannot be reprocessed or remolded in any way, rendering the recycling of fibers from these parts a particularly challenging task. Traditionally, thermoset CFRC waste has been incinerated or disposed of in landfills. This has led to high disposal costs and negative environmental impacts.

The thermoset matrices of composites deteriorate under mechanical and thermal stresses or undergo chemical degradation with repeated use and age. However, the carbon fibers within the composites remain intact because they have high thermal, chemical, and mechanical stability. Thus, carbon fibers can be recovered from end-of-life cured composites and from partially cured ‘pre-preg’ scraps with minimal loss in properties. Reusing recovered carbon fibers eliminates the large amount of energy required to produce virgin carbon fibers. Therefore, there is a growing need to develop a method to degrade the epoxy matrix from thermoset composites and then reclaim continuous carbon fibers.

Current techniques for deteriorating the matrix and recovering carbon fibers can be classified into mechanical methods, solvolysis, pyrolysis, and electrochemical methods. Mechanical methods include grinding and milling. These methods produce only short carbon fibers; composites made using chopped fibers are not competitive with CFRCs made from continuous fibers. In the solvolysis method, organic solvents are used to degrade the epoxy matrix. However, this process is time-consuming, and the solvents are environmentally hazardous. Supercritical fluids have also been investigated for use in solvolysis. These fluids require equipment that can withstand high pressures and temperatures, thus increasing capital costs. In electrochemical methods, chlorination inside an electrochemical cell degrades the epoxy matrix. Disadvantages of this method include the post-process drying of the carbon fibers, the long process times, the requirement of large volumes of electrolytes, and the use of expensive materials such as platinum electrodes; these factors make this process difficult to scale up.

Oven pyrolysis is currently the most commonly used method for carbon fiber recycling. In this method, the matrix is decomposed in an inert environment at temperatures ranging from 350° C. to 700° C. This process is conventionally carried out in large-scale ovens. Pyrolysis is typically followed by oxidation of the retrieved carbon fibers to remove the epoxy char on the surface of the fibers. The entire process, including oxidation, requires a minimum of about 30 min for a sample size of 250 g.

Another method that uses high temperatures for carbon fiber recycling is the fluidized bed process, which involves heating the CFRC composite using air between 450-550° C. in a bubbling sand bed. The major drawback of the fluidized bed method is that initial continuous fibers are broken down into short and fluffy chopped fibers.

### SUMMARY OF THE INVENTION

This summary is provided to introduce a selection of concepts that are further described below in the Detailed Description. This summary is not intended to identify key or essential features of the claimed subject matter, nor is it to be used as an aid in limiting the scope of the claimed subject matter.

The instant methods avoid the problems associated with existing technologies via Joule heating. Joule heating, or resistive heating, occurs when an electric current is passed through a conductive material. The instant methods provide out-of-oven thermal recycling of carbon fibers from scrap composites. FIG. 1 illustrates a method of recycling carbon fiber composites using electromagnetic fields. A DC voltage is applied across a CFRC using a DC power source; the conductive carbon fibers enable a current to pass through the CFRC, heating up the carbon fibers in the process. The heated carbon fibers in turn heat up the surrounding matrix, and, since the degradation temperature of the carbon fibers is much higher than that of the matrix, the process temperature can be monitored (e.g., via a thermal camera or other temperature sensing devices) and controlled to target degradation of the matrix without affecting the carbon fibers specifically.

Carbon fibers retrieved using this method were characterized and compared against fibers recycled using conventional oven pyrolysis; surface characteristics and fiber strength turned out to be consistent across samples degraded using the two heating methods. Next, to test the utility of the recycled fibers, recycled carbon fiber composites (rCFRCs) were made by reinfiltrating the fibers with epoxy and curing the composite; similar mechanical results were obtained for the composites made using fibers recycled via DC heating and conventional oven pyrolysis. Finally, the scalability of this method was investigated by finding a relationship between the power required for composites of various sizes.

In an embodiment, the present disclosure pertains to a method of recycling. In general, the method includes applying an electromagnetic field to a composite material having carbon fiber therein, heating the composition, degrading a matrix of the composite material, and recovering the carbon fiber from the composite material. In some embodiments, the electromagnetic field is applied in a non-contact manner.

In an additional embodiment, the present disclosure pertains to a method of non-contact recycling. In general, the method includes applying an electromagnetic field to a composite material having carbon fiber therein with an electromagnetic applicator via at least one of direct current or alternating current, heating the composition, degrading a matrix of the composite material, and recovering the carbon fiber from the composite material. In some embodiments, the electromagnetic field is applied in a non-contact manner. In some embodiments, the heating is locally induced heating that includes increasing the temperature inside the composite material via an inside-out method thereby initiating pyrolysis within the composite material.

### BRIEF DESCRIPTION OF THE DRAWINGS

A more complete understanding of the subject matter of the present disclosure may be obtained by reference to the following Detailed Description when taken in conjunction with the accompanying Drawings wherein:

FIG. 1 illustrates a method of recycling carbon fiber composites using electromagnetic fields; and

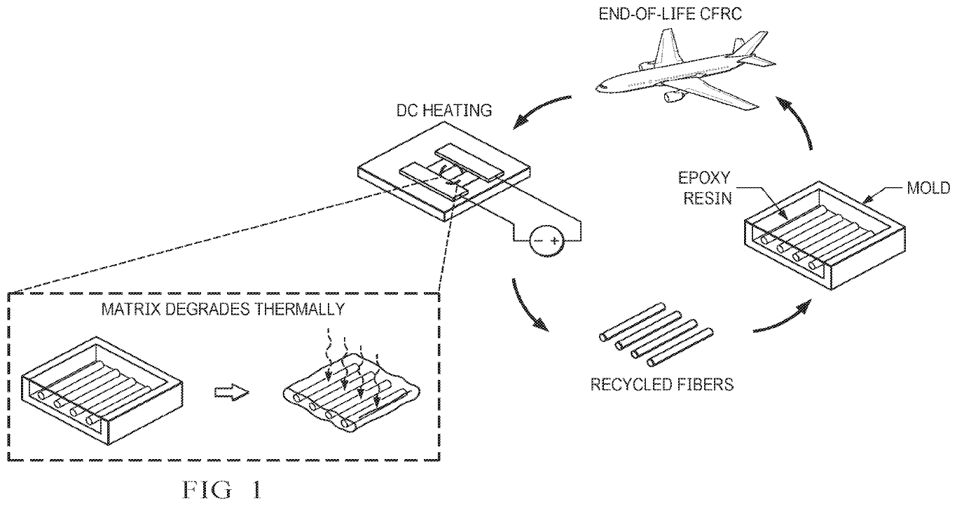

FIG. 2 illustrates a system for recycling carbon fiber composites using electromagnetic fields.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. The section headings used herein are for organizational purposes and are not to be construed as limiting the subject matter described.

Several different carbon fiber composite recycling techniques have been utilized in the last two decades. Two of the most common recycling techniques are: (1) mechanical processes, such as, for example, milling and grinding; and (2) thermal processes, such as, for example pyrolysis and solvolysis. Mechanical grinding has mostly proven feasible to retrieve glass fibers, while thermal processes, such as pyrolysis, allow for recovery of carbon fiber. However, with pyrolysis, the resin is volatilized into lower-weight molecules, resulting in gases (e.g., carbon dioxide, hydrogen, and methane), an oil fraction, and char on the fibers. In this process, the composites are heated to temperatures of approximate 350 to 800° C. to pyrolyze the matrix, and the energy intake can be as high as 30 MJ/kg. Solvolysis generally includes a chemical treatment using a solvent to degrade the resin, and solvolysis reactors usually vary temperature and pressure to accelerate the degradation of the resin. Despite the popular use of mechanical and thermal recycling processes, several limitations exist, and can include, for example, lack of industrial scaleup that can greatly hinder the recycling processes.

As briefly discussed above, two of the most common carbon fiber recycling techniques are mechanical processes and thermal processes. The processes can include, for example, milling, grinding, pyrolysis, and solvolysis. Among existing methods, pyrolysis is the least energy intensive process for recycling carbon fiber and also results in higher quality reclaimed fibers. Despite these advantages, pyrolysis has several limitations for industrial scaleup. One issue is the generation of greenhouse gases, such as, for example, carbon dioxide (CO₂). The mass of the generated gas scales with the total mass of the matrix that is to be entirely removed to reclaim the fibers. Another major challenge is associated with the mode of heating currently used. In a conventional pyrolysis carbon fiber recycling setup, the composite is heated inside a convection oven. Because conventional pyrolysis is a surface heating technique, thermal diffusion timescales scale with the thickness of the part being pyrolyzed. In fact, it is for this reason that parts are typically shredded or crushed into smaller pieces prior to pyrolysis.

As an alternative to conventional pyrolysis using ovens, heating can be done via electromagnetic fields. For example, carbon fibers rapidly heat in response to ˜100 MHZ electromagnetic fields. Such fields may be applied in a non-contact manner, for example, via parallel plate applicators or via coplanar applicators that produce an orthogonal fringing field. Further, it has been previously demonstrated that such a technique may be used in composite manufacturing. As such, the present disclosure identifies that composites containing carbon fibers can be heated up using electromagnetic fields applied by parallel plate or coplanar applicators to degrade the matrix, thus allowing for carbon fiber to be recovered and recycled. The methods of the present disclosure apply to two separate approaches. First, local heating of the carbon fiber can cause local degradation of the matrix, allowing for matrix debonding. In order to recover the carbon fiber, mild mechanical post-processing can follow. For example, grinding, milling, abrading, etc. may be used. Second, the carbon fiber can be heated up to degradation temperatures for an extended period, thus allowing for complete pyrolysis of the sample—this approach is more straightforward than the carbon fiber recycling methods currently employed.

Reference will now be made to more specific embodiments of the present disclosure and data that provides support for such embodiments. However, it should be noted that the disclosure below is for illustrative purposes only and is not intended to limit the scope of the claimed subject matter in any way.

In various embodiments, an electromagnetic field is applied, through either direct or alternating current. The electromagnetic field can be applied to the composite through a non-contact applicator (e.g., a parallel plate or coplanar applicator). The electromagnetic field causes Joule heating of the carbon fibers within the composite to pyrolyze the matrix, allowing for the valuable carbon fibers to be separated from the composite and recycled. The carbon fibers may comprise any of a variety of forms, including sheets, individual fibers, etc. In contrast to existing techniques, which require significant utilities, larger footprints, and higher capital and operating costs, the present disclosure leverages electromagnetic fields to separate carbon fibers with fewer utilities, smaller footprints, and less capital operating costs. This ultimately allows for reclaiming, recycling, and reuse the carbon fiber in much more efficient and environmentally friendly way.

In some embodiments, the electromagnetic field is applied through at least one of direct current or alternating current. In some embodiments, the electromagnetic field has a frequency in a range between 75 to 125 MHz. In some embodiments, the electromagnetic field is applied via an applicator that can include, without limitation, parallel plate applicators, coplanar applicators, radio frequency applicators, and combinations thereof. In some embodiments, the electromagnetic field is applied via utilization of coplanar applicators that produce an orthogonal fringing field. In some embodiments, the heating is applied via a fringing field capacitor utilizing radio frequency alternating current. In some embodiments utilizing fringing fields, parallel metal plates, traces, or lines are set up as a capacitor (with fairly low spacing between the plates, traces or lines on the order of millimeters), and the sample is placed in the fringing field just above the electrodes. The proximity of the sample is typically on the order of millimeters. The electromagnetic field produced by the RF applicator heats the matrix via resistive heating of the carbon fibers within the composite.

In some embodiments, the heating is locally induced heating. In some embodiments, the heating includes increasing the temperature inside the composite material via an inside-out method. In some embodiments, the carbon fiber recovered from the composite materials are continuous carbon fiber sheets.

In some embodiments, the method further includes mechanical post-processing of the recovered carbon fiber. The mechanical post processing may include one or more of grinding, milling, abrading, and the like. In some embodiments, the heating is conducted in an inert atmosphere. The inert atmosphere may comprise nitrogen or argon. In some embodiments, the heating includes initiating pyrolysis within the composite material (i.e., not via an oven as in conventional pyrolysis methods).

In an additional embodiment, the present disclosure pertains to a method of non-contact recycling. In general, the method includes applying an electromagnetic field with an electromagnetic field applicator to a composite material having carbon fiber therein. The electromagnetic applicator is supplied with a direct current or alternating current to generate the electromagnetic field. The electromagnetic field induces Joule heating in the carbon fibers. The heat from the carbon fibers is transferred, in part, to the surrounding matrix of the composite material and degraded. Once the matrix has sufficiently degraded, the carbon fibers may be recovered from the composite material. In some embodiments, the electromagnetic field is applied in a non-contact manner. For example, the composite material is placed within a few millimeters of the applicator, but without contacting the applicator. In some embodiments, the heating is locally induced heating that includes increasing the temperature inside the composite material via an inside-out method thereby initiating pyrolysis within the composite material.

In some embodiments, the electromagnetic applicator can include, without limitation, parallel plate applicators, coplanar applicators, radio frequency applicators, and combinations thereof. In some embodiments, the electromagnetic applicator utilizes coplanar applicators that produce an orthogonal fringing field. In some embodiments, the heating is applied via a fringing field capacitor utilizing radio frequency alternating current. In some embodiments, the electromagnetic field has a frequency in a range between 75 to 125 MHz.

Reference will now be made to particular materials and methods utilized by various embodiments of the present disclosure. However, it should be noted that the materials and methods presented below is for illustrative purposes only and is not intended to limit the scope of the claimed subject matter in any way.

The methods of recycling carbon fiber via electromagnetic fields can have numerous advantages. For example, instead of solvent-using or furnace-based pyrolysis, the methods of recycling carbon fiber of the present disclosure use only electricity, allowing for significant emissions savings, especially with respect to utility usage and cost. Additionally, utilization of the methods for recycling carbon fiber as detailed herein advantageously impact the overall footprint of recycling systems. For instance, rather than having 10-foot furnaces for pyrolysis, the methods of recycling carbon fiber herein can utilize 10-cm long radio frequency applicators to locally induce heating. This means that low-infrastructure, distributed recycling of carbon fiber can be carried out. Moreover, the processes of recycling carbon fiber as disclosed herein utilize an inside-out heating approach. By heating from the carbon fiber via electromagnetic fields, the total amount of heat that must be generated is minimized, which is in stark contrast to conventional oven-based pyrolysis. Furthermore, the methods of recycling carbon fiber according to aspects of the present disclosure have less stringent requirements for the environment (e.g., use of inert atmosphere), as pyrolysis will initiate from within.

The relevant degradation temperatures of the matrix were determined using thermogravimetric analysis (TGA). A temperature ramp from room temperature to 600° C. (in air) showed that the matrix for the cross-weave and unidirectional composites used in this study degraded at around 400° C. Next, isothermal TGA runs in air at 400° C. showed that at the end of 10 min, the cross-weave composite had a residue of 77%, while the unidirectional composite had a residue of 55%. These numbers roughly correspond to the fiber to matrix weight ratio in the composite, and we aimed to achieve these ratios with our DC heating experiments.

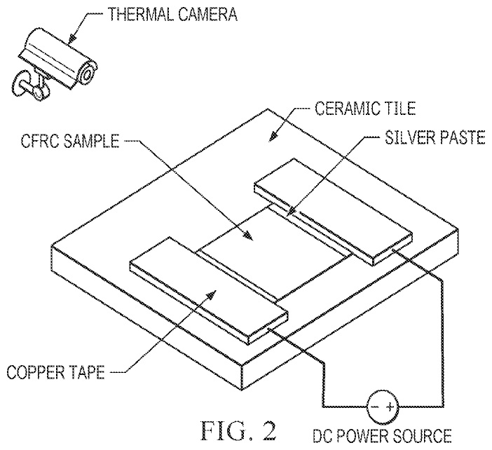

Next, the DC heating methodology was used to degrade the matrix for recovery of carbon fibers. FIG. 2 illustrates a system for recycling carbon fiber composites using electromagnetic fields. A current was allowed to pass through 4-ply thick samples of cross-weave and unidirectional composites with in-plane dimensions 1 cm×1 cm. This allowed the conductive carbon fibers to heat up volumetrically and transfer the heat to the surrounding resin. A temperature of 400° C. was maintained for about 10 min by modulating the DC voltage, based on feedback from the thermal camera; uniform heating of the sample was observed, which ensured that the matrix in the entire sample was evenly degraded. Visual observation confirmed that after the elapsed time, the matrix was eliminated, and the fibers had begun to fray and separate.

To show that this method can be scaled up to continuous composite rolls, longer composites of in-plane dimensions approximately 7 cm×1 cm were heated; the temperature was rapidly ramped up to about 400° C. within a minute and maintained isothermally for 10 min. Typical weights of the composite before and after DC heating are shown in Table 1; these weight ratios were close to the ones obtained from TGA.

TABLE 1
Weights of cross-weave and unidirectional composites
taken before and after DC Heating.

| | Weight before | Weight after |
|---|---|---|
| Composite | heating (g) | heating (g) |
| Cross-weave | 0.81 | 0.68 |
| Unidirectional | 0.75 | 0.44 |

Table 1 shows that DC heating can be successfully used to recycle continuous carbon fibers from scrap CFRCs, without using environmentally hazardous reagents.

The surface chemistry of the recovered carbon fibers was analyzed using X-ray photoelectron spectroscopy (XPS). The as received carbon fibers show O and C peaks, but do not show any N peaks. These as-received fibers have a thin coating on them which enhances cross-linking between the fiber and matrix; this is called ‘sizing.’ The as-received fibers were thermally treated at 450° C. for 15 min to remove the sizing.

After removal of the sizing on the fibers, the ‘de-sized’ carbon fibers show N, C, and O peaks. The N peak that appears in the de-sized carbon fibers belongs to the N atoms present in the carbon fiber itself (remnants of the polyacrylonitrile-based precursor) and the amine (NH2) functional groups. After the DC-recycling process, the N peak becomes stronger compared to the de-sized carbon fiber. C, O, and N percentages for each carbon fiber are listed in Table 2.

TABLE 2
Elemental compositions of IM7 CFs exposed to
various treatments as determined by XPS.

| Procedure | C % | O % | N % |
|---|---|---|---|
| As-received CF | 82.6 | 17.4 | — |
| De-sized | 82.8 | 14.1 | 3.1 |
| DC-Recycled CF | 83.2 | 10.7 | 6.1 |
| Oven-Recycled CF | 81.7 | 10.5 | 7.8 |

The as-received carbon fibers and de-sized carbon fibers have a slightly higher O/C ratio (21% and 17%, respectively) than the DC-recycled ones (12.9%). The O/C ratio quantifies the oxygen-containing functional groups on the surfaces of the carbon fibers and indicates the active surface area of chemical bonding between the carbon fibers and epoxy resin. The as-received carbon fibers and de-sized carbon fibers may have a slightly higher O/C ratio than the DC-recycled ones because de-sizing and DC recycling slightly oxidizes the surface of carbon fibers and cleaves the functional groups that contain oxygen.

The functional groups on the fiber surface were determined by C 1s deconvoluted spectra. The C 1s narrow spectra were deconvoluted to show three peaks, namely C—C (284.4 eV), C—O—C (285.02-286.03 eV), and O—C═O (287.9-288.4 eV), according to their distinguished binding energy. The contents of the functional groups are listed in Table 3.

TABLE 3
The relative contents of functional groups on the surfaces
of carbon fibers exposed to different treatments determined
by deconvoluted C 1s XPS spectra.

| | C—C | | C—O—C | | O—C═O | |
|---|---|---|---|---|---|---|
| PROCEDURE | Position | % | Position | % | Position | % |
| As-received CF | 284.5 | 69.5 | 286.2 | 26.7 | 288.0 | 3.8 |
| Desized CF | 284.4 | 44.1 | 285.3 | 48.2 | 288.1 | 7.7 |
| DC-Recycled CF | 284.6 | 30.6 | 285.1 | 57.3 | 288.2 | 12.0 |
| Oven-Recycled CF | 284.4 | 43.4 | 285.6 | 36.8 | 287.9 | 19.8 |

The same types of functional groups were found on the surfaces of recycled and as-received fibers. These functional groups help create covalent bonds between the carbon fibers and the epoxy matrix during re-impregnation. The DC-recycled carbon fibers have a noticeably higher density of hydroxyl groups and carbonyl groups compared to de-sized carbon fibers. This is likely because the DC recycling of CFRC composites leaves some functional groups from the original matrix on the surface of the carbon fibers.

The surface morphologies of as-received, DC-recycled, and oven-recycled carbon fibers were investigated via scanning electron microscopy and optical microscopy. No major damage on carbon fibers was observed in the SEM images. Also, there is very little epoxy remaining on the surface of the DC-recycled carbon fibers. This residue was removed after washing the carbon fibers in an ultrasonic bath.

Tensile testing of recycled individual carbon fibers was performed to measure the tensile strength and modulus, and to determine if their mechanical properties were altered during recycling. Fibers recycled using DC heating and oven pyrolysis have similar modulus values of around 180-190 GPa. However, we see an about 10-15% decrease in tensile strength of DC and oven-recycled fibers when compared to as-received fibers. This loss in strength is consistent with previous studies which involved thermal degradation of the matrix to reclaim carbon fibers.

Incineration of CFRCs produces 3.39 kg of CO₂ per kg of CFRC waste. Greenhouse gas emissions associated with virgin carbon fiber production have been estimated previously at 31 kg CO₂ equivalent per kg, which is 10 times more than conventional steel at 3 kg CO₂ equivalent per kg production. Recovering carbon fibers from CFRC wastes could help compensate for these production impacts and reduce the greenhouse emissions from incineration. Additionally, recycling of carbon fibers from CFRCs is of growing importance on account of environmental legislation becoming stricter by the day. Thus, it is imperative to adopt a sustainable method to recycle carbon fibers. In this work, we have successfully established DC heating as an effective methodology to recycle continuous carbon fibers from end-of-life composites.

To demonstrate applications of recycled carbon fibers, we fabricated rCFRCs, which were 4-ply thick with in-plane dimensions 70 mm×10 mm using the same resin system as the initial composites. The mechanical properties of composites made using fibers recycled via both DC heating and conventional pyrolysis were compared. A composite of similar dimensions made from as-received IM7 fibers was used as a control specimen. Composites made using DC-recycled and oven-recycled fibers had similar modulus values; however, these values are about 20% lower than the modulus of composite made using as-received fibers. The tensile strength of composites made from DC-recycled fibers was measured to be about 440.5 GPa, which is higher than the value observed for composites made using oven-recycled fibers (around 362.9 GPa). Drops of approximately 20% and 37% in tensile strengths were observed for the composites made using DC heating, and oven heating recycled fibers, respectively, compared to the control specimen.

The drop in mechanical properties of DC-recycled rCFRCs when compared to composites made using as-received fibers may be attributed to the fact that thermal treatment (both DC heating and oven pyrolysis) removes the sizing of carbon fibers.

The sizing is a highly proprietary coating on virgin carbon fibers, which enhances cross-linking between fiber and matrix and strengthens the fiber-matrix interface; thus, its absence in recycled fibers affects the modulus and strength of the final cured part. Reapplying the sizing on these recycled fibers could likely improve the mechanical properties of the resulting rCFRCs; however, due to its unknown nature, re-sizing can only be carried out by the fiber manufacturer. Composites made of fibers recycled using DC heating fared significantly better when compared against composites made using conventionally recycled fibers.

Next, the scalability of this methodology was analyzed to investigate the potential transfer of technology from the laboratory to the industry. The power and energy required to recycle composites of varying sizes and weights were measured.

Power required for recycling was plotted against the composite volume; the plot follows a sub-linear relationship. Moreover, it was seen that the energy required per unit mass for recycling decreases with an increase in sample weight. Thus, this methodology of recycling continuous carbon fibers can be potentially ramped up to a commercial scale without an extreme rise in energy usage.

### Experimental Section

### Materials

For this study, thermoset composites with IM7 (Hexcel, Stamford, CT) carbon fibers were used. The first type of composite had unidirectional carbon fibers impregnated with epoxy made from EPON 862 epoxide cured with Epikure W (Miller-Stephenson, Danbury, CT); the second composite used in this study had the same matrix system with the cross-weave IM7 carbon fibers cured with the same matrix. Both composites were 4 layers thick and were cured at 121° C. for 1 h, followed by 177° C. for 2.5 h using a heated platen press.

### Thermogravimetric Analysis

TGA ramp experiments were performed in the air for cross-weave and unidirectional composites to determine the degradation temperature of the matrix; the temperature was ramped from room temperature to 600° C. at a rate of 10° C. min⁻¹. Next, isothermal TGA experiments were performed at the degradation temperature determined from the temperature run; the sample was heated rapidly to the degradation temperature and held isothermally for 10 min. The residual weight at the end of each run was noted.

### DC Heating

The DC heating setup used for recycling carbon fibers is shown in FIG. 2. The CFRC composite was placed on a ceramic tile and copper tape was attached to the ends of the composite; silver paste was used to ensure proper electrical contact between the tape and the composite. Alligator clips were used to connect the copper tapes to a direct current power source. The DC supply voltage was modulated manually to ramp up the sample to its target temperature and maintain it for the desired residence time. The temperature was monitored using a FLIR A655sc thermal camera.

### X-Ray Photoelectron Spectroscopy

XPS was performed on carbon fibers using an Omicron X-ray photoelectron spectrometer employing an Mg-sourced X-ray beam at 15 kV with aperture 3. The scan spectra were recorded in the range 0-1100 eV. The carbon (C), nitrogen (N), and oxygen (O) traces were scanned. The binding energy was calibrated by referring to the C Is peak at 284.8 eV. For this characterization, some as-received fibers were thermally treated at 450° C. for 15 min to remove the proprietary coating or ‘sizing’; these fibers are referred to as “de-sized” fibers. XPS scans of as-received carbon fibers, de-sized carbon fibers, oven-recycled carbon fibers, and DC-recycled carbon fibers were compared.

### Scanning Electron Microscopy

The surface morphologies of the as-received, DC-recycled and oven-recycled carbon fibers were observed using a scanning electron microscope (Tescan LYRA-3 Model GMH Focused Ion Beam Microscope) to investigate the degree of degradation of the resin matrix and potential damage to the fiber surfaces. The operating accelerating voltage was 10 kV.

### Single Fiber Testing

Unidirectional carbon fibers extracted from composites thermally treated using DC heating and conventional oven pyrolysis were used for single fiber mechanical testing. A paper sample tab with a gauge length of 10 mm was used to mount the samples to the tensile stage. The strain rate was set to be 0.5 mms-1, and a minimum of 20 samples were tested from each fiber type. Modulus and tensile strength were measured for each fiber type using the data from this experiment. As-received unidirectional IM7 fibers were used as the control specimen for this experiment.

### Matrix Reinfiltration and Mechanical Testing of Composites

After DC heating or oven pyrolysis, the laminas in 4-ply cross-weave composites were separated for cleaning. The laminas were kept in an ultrasonic bath of deionized water for 15 min at room temperature to remove traces of the residual epoxy. Once dried, an aluminum mold with in-plane dimensions of 70.5 mm×10.5 mm was used for making composites from the recycled fibers. Layers (or lamina) of the fibers were laid one by one, and each layer was impregnated with the same resin system used to make the original composite. The curing cycle consisted of keeping the system at 121° C. for 1 h, followed by 177° C. for 2.5 h in a heated platen press.

Composites with dimensions of 70 mm×10 mm made of fibers recycled using DC heating or oven pyrolysis were mechanically tested to measure tensile strength and modulus. An Instron model #2630-101 frame with a 50 kN load cell was used for these tests; the displacement rate was set at 1.27 mm min⁻¹ for all tests. Composite made using as-received IM7 weave was used as the control specimen for these tests.

Although various embodiments of the present disclosure have been described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially”, “approximately”, “generally”, and “about” may be substituted with “within [a percentage] of” what is specified, where the percentage includes 0.1, 1, 5, and 10 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a”, “an”, and other singular terms are intended to include the plural forms thereof unless specifically excluded.

What is claimed is:

1. A method of recycling, the method comprising:
applying an electromagnetic field to a composite material comprising carbon fiber;
heating, via the electromagnetic field, the carbon fiber;
degrading, via the heated carbon fiber, a matrix of the composite material; and
recovering the carbon fiber from the composite material.

2. The method of claim 1, wherein the electromagnetic field is applied through at least one of direct current or alternating current.

3. The method of claim 1, wherein the electromagnetic field has a frequency in a range between 75 to 125 MHz.

4. The method of claim 1, wherein the electromagnetic field is applied via an applicator selected from the group consisting of parallel plate applicators, coplanar applicators, radio frequency applicators, and combinations thereof.

5. The method of claim 1, wherein the electromagnetic field is applied via utilization of a coplanar applicator that produces an orthogonal fringing field.

6. The method of claim 1, wherein the heating is applied via a fringing field capacitor utilizing radio frequency alternating current.

7. The method of claim 1, wherein the heating is locally induced heating.

8. The method of claim 1, wherein the heating comprising increasing the temperature inside the composite material via an inside-out method.

9. The method of claim 1, wherein the carbon fiber recovered from the composite materials are continuous carbon fiber sheets.

10. The method of claim 1, further comprising mechanical post-processing of the recovered carbon fiber.

11. The method of claim 1, wherein the hearting is conducted in an inert atmosphere.

12. The method of claim 1, wherein the heating comprises initiating pyrolysis within the composite material.

13. A method of non-contact recycling, the method comprising:
applying, via an electromagnetic applicator, an electromagnetic field to a composite material comprising carbon fiber, wherein the electromagnetic field is applied in a non-contact manner;
heating the composite material via the electromagnetic field, wherein the heating is locally induced heating of the carbon fibers that increases a temperature inside the composite material via an inside-out method thereby initiating pyrolysis within the composite material; and
recovering the carbon fiber from the composite material.

14. The method of claim 13, wherein the electromagnetic applicator is selected from the group consisting of parallel plate applicators, coplanar applicators, radio frequency applicators, and combinations thereof.

15. The method of claim 13, wherein the electromagnetic applicator utilizes coplanar applicators that produce an orthogonal fringing field.

16. The method of claim 13, wherein the heating is applied via a fringing field capacitor utilizing radio frequency alternating current.

17. The method of claim 13, wherein the electromagnetic field has a frequency in a range between 75 to 125 MHz.

18. The method of claim 13, wherein the carbon fiber recovered from the composite materials are continuous carbon fiber sheets.

19. The method of claim 13, further comprising mechanical post-processing of the recovered carbon fiber.

20. The method of claim 13, wherein the heating is conducted in an inert atmosphere.
